(19) United States
(12) Patent Application Publication
(10) Pub. No.: US 2026/0080222 A1
(43) Pub. Date: Mar. 19, 2026

(54) USE OF MULTIPLE LLMS WITH LEARNING COMPONENT

(71) Applicant: Lenovo (United States) Inc., Morrisville, NC (US)

(72) Inventors: John W Nicholson, Morrisville, NC (US); Daryl C Cromer, Morrisville, NC (US); Howard Locker, Morrisville, NC (US); Xiaohua Xu, Morrisville, NC (US)

(21) Appl. No.: 18/886,810

(22) Filed: Sep. 16, 2024

(51) Int. Cl. G06N 3/0475; G06N 3/045; G06N 3/08

(52) U.S. Cl. CPC G06N 3/0475; G06N 3/045; G06N 3/08

(57) ABSTRACT

In one aspect, a device includes a processor system and storage. The storage includes instructions executable by the processor system to receive a prompt, and to provide the prompt as first input to a first large language model (LLM). Based on providing the prompt as first input to the first LLM, the instructions are executable to receive a first output from the first LLM that indicates first generative text. The instructions are further executable to provide the prompt as second input to a second LLM, and to receive a second output from the second LLM based on providing the prompt as second input to the second LLM. The second output also indicates second generative text. The instructions are then executable to concurrently present, on a display, the first and second generative texts. Present principles may also be applied to generative image and generative audio models.

### FIELD

The disclosure below relates to technically inventive, non-routine solutions that are necessarily rooted in computer technology and that produce concrete technical improvements. In particular, the disclosure below relates to techniques for use of multiple large language models (LLMs).

### BACKGROUND

As recognized herein, there has been a proliferation of LLMs available to the public. However, not all LLMs are the same, with some being better than others. Current technology fails to provide a way to adequately gauge the quality of these various LLMs and to select the best one(s) for a given implementation. As such, no adequate solutions currently exist to the foregoing computer-related, technological problem.

### SUMMARY

Accordingly, in one aspect a device includes a processor system and storage accessible to the processor system. The storage includes instructions executable by the processor system to receive a prompt and to provide the prompt as first input to a first large language model (LLM). The instructions are also executable to, based on providing the prompt as first input to the first LLM, receive a first output from the first LLM. The first output indicates first generative text. The instructions are also executable to provide the prompt as second input to a second LLM and to, based on providing the prompt as second input to the second LLM, receive a second output from the second LLM. The second output indicates second generative text. The instructions are then executable to concurrently present the first and second generative texts on a display.

In some example implementations, the instructions may be executable to present, concurrently on the display with the first and second generative texts, a composition area where different aspects of the first and second generative texts that are selected by a user are presentable such that the user can take different parts of the first and second generative texts and place them into the composition area to establish third text.

Also in some example implementations, the instructions may be executable to, over n>1 instances of presenting different generative texts on the display based on a respective prompt, identify a user’s preference for a particular LLM’s outputs based on the user selecting outputs from the particular LLM more than outputs from other LLMs. Based on the user’s preference, the instructions are executable to prioritize future outputs from the particular LLM for presentation over outputs from other LLMs. In one particular instance, the user’s preference may pertain to a particular type of subject such that the user is identified as having a first LLM preference for a first type of subject and a second LLM preference for a second type of subject.

Also in some example implementations, the instructions may be executable to concurrently present, in a vertical sequence on the display and/or in a horizontal sequence on the display, the first and second generative texts. Also, if desired the instructions may be executable to use a third LLM to synthesize the first and second generative texts into third text. The third LLM may be the same as either of the first or second LLMs, or may be different from them. Additionally or alternatively, the instructions may be executable to concurrently present the first and second generative texts as combined text, such as by rendering the combined text on the display as a marked-up version of a single body of text.

Also in example implementations, the prompt may be the same as provided to both the first and second LLMs as input. Additionally, the second LLM may be different from the first LLM, and the device itself may include the display if desired.

In another aspect, a method includes receiving a prompt and providing the prompt as first input to a first large language model (LLM). Based on providing the prompt as first input to the first LLM, the method includes receiving a first output from the first LLM, with the first output indicating first generative text. The method also includes providing the prompt as second input to a second LLM and, based on providing the prompt as second input to the second LLM, receiving a second output from the second LLM. The second output indicates second generative text. The method further includes concurrently presenting, on a display, the first and second generative texts.

In some instances, the method may also include presenting, concurrently on the display with the first and second generative texts, a composition area where different aspects of the first and second generative texts that are selected by a user are presentable such that the user can take different parts of the first and second generative texts and place them into the composition area to establish third text.

Still further, in some cases, the method may include, over n>1 instances of presenting different generative texts on the display based on a respective prompt, identifying a user’s preference for a particular LLM’s outputs based on the user selecting outputs from the particular LLM more than outputs from other LLMs. Here, based on the user’s preference, the method may then include prioritizing future outputs from the particular LLM for presentation over outputs from other LLMs. In certain specific instances, the user’s preference may pertain to a particular type of subject such that the user is identified as having a first LLM preference for a first type of subject and a second LLM preference for a second type of subject different from the first type of subject.

Additionally, if desired the prompt may be the same as provided to both the first and second LLMs as input, while the second LLM may be different from the first LLM.

In still another aspect, at least one computer readable storage medium (CRSM) that is not a transitory signal includes instructions. The instructions are executable by a processor system to receive a prompt, and to provide the prompt as first input to a model. The instructions are also executable to, based on providing the prompt as first input to the first model, receive a first generative output from the first model. The instructions are then executable to provide the prompt as second input to a second model, with the second model being different from the first model. Based on providing the prompt as second input to the second model, the instructions are executable to receive a second generative output from the second model, and to concurrently present the first and second generative outputs on a display.

In some example implementations, the first and second generative outputs may include generative text.

Also in some example implementations, the first and second generative outputs may include generative audio and/or generative images.

The details of present principles, both as to their structure and operation, can best be understood in reference to the accompanying drawings, in which like reference numerals refer to like parts, and in which:

### BRIEF DESCRIPTION OF THE DRAWINGS

FIG. 1 is a block diagram of an example system consistent with present principles;

FIG. 2 is a block diagram of an example network of devices consistent with present principles;

FIG. 3 is a schematic diagram illustrating how different generative outputs from different LLMs can be prioritized consistent with present principles;

FIGS. 4 and 5 show example graphical user interfaces (GUIs) on which different generative outputs that have been prioritized can be presented consistent with present principles;

FIGS. 6 and 7 show example GUIs that may be used to select and edit generative outputs from one or more generative models to compose user-desired text consistent with present principles;

FIG. 8 illustrates example logic in example flow chart format that may be executed by a device consistent with present principles; and

FIG. 9 shows an example settings GUI that may be used to configure one or more settings of a device or application (“app”) to execute consistent with present principles.

### DETAILED DESCRIPTION

Among other things, the detailed description below describes devices and methods that are directed to use of multiple large language models (LLMs) along with implementation of a digital learning component. While recognizing herein that a user’s preference for one LLM or another can be qualitative and subjective in nature, present principles propose a software solution for optimizing LLM outputs based on the individual user. Certain LLMs and outputs might therefore be prioritized that reflect the user’s purpose, values, beliefs, tone, background, etc.

Accordingly, in one example implementation, a user may create a prompt, which is then sent to a set of LLMs or other generative services. The LLM set can be a set of popular LLMs, low cost LLMs, specialized LLMs, etc. LLM responses are then returned and presented to the user. A user interface can then be used by the user to combine LLM outputs by picking-and-choosing which parts of the multiple LLM responses they would like to use. The UI can present text with a track changes feature, and/or the text can be presented with a compare document feature. Additionally or alternatively, the UI can include a merge tool to merge the LLM responses. The UI may also include a selector to “update the response to include [payload/part of response from another LLM]”, and/or a prompt may be received from the user to that effect, and the tool (e.g., using another LLM) may then act accordingly to merge the primary response/LLM output with the indicated part of another LLM’s output. Thus, more generally, highlighted parts of the LLM responses may be synthesized by another LLM.

If desired, an additional learning component may also be included. So as the user selects the LLM response(s) they prefer (or parts thereof), the device/app tracks the user’s preference(s) on LLMs, grouped by semantic category of the prompt (e.g., political, technical, social, general info, etc.). The learning component can then be used to weight the LLMs for future responses and then present subsequent generative results in a weighted manner, making selection easier. As the user prompts increase, the preferences and weighting can become stronger. Additionally, infrequently-selected LLMs, and/or low-performing and low-weighted LLMs, may be removed from the LLM query set and possibly replaced with alternate LLMs such that the former LLMs are no longer used for generative outputs once they fall below a weighting threshold and/or use threshold (e.g., some or all generative output from the respective LLM used in less than five percent of all instances).

Prior to delving further into the details of the instant techniques, note with respect to any computer systems discussed herein that a system may include server and client components, connected over a network such that data may be exchanged between the client and server components. The client components may include one or more computing devices including televisions (e.g., smart TVs, Internet-enabled TVs), computers such as desktops, laptops and tablet computers, so-called convertible devices (e.g., having a tablet configuration and laptop configuration), and other mobile devices including smart phones. These client devices may employ, as non-limiting examples, operating systems from Apple Inc. of Cupertino CA, Google Inc. of Mountain View, CA, or Microsoft Corp. of Redmond, WA. A Unix® or similar such as Linux® operating system may be used, as may a Chrome or Android or Windows or macOS or iOS operating system. These operating systems can execute one or more browsers such as a browser made by Microsoft or Google or Mozilla or another browser program that can access web pages and applications hosted by Internet servers over a network such as the Internet, a local intranet, or a virtual private network.

As used herein, instructions refer to computer-implemented steps for processing information in the system. Instructions can be implemented in software, firmware or hardware, or combinations thereof and include any type of programmed step undertaken by components of the system; hence, illustrative components, blocks, modules, circuits, and steps are sometimes set forth in terms of their functionality.

A processor may be any single- or multi-chip processor that can execute logic by means of various lines such as address lines, data lines, and control lines and registers and shift registers. Moreover, any logical blocks, modules, and circuits described herein can be implemented or performed with a system processor such as a central processing unit (CPU), a graphics processing unit (GPU), a neural processing unit (NPU), a digital signal processor (DSP), a field programmable gate array (FPGA) or other programmable logic device such as an application specific integrated circuit (ASIC), discrete gate or transistor logic, discrete hardware components, or any combination thereof designed to perform the functions described herein. A processor can also be implemented by a controller or state machine or a combination of computing devices. Thus, the methods herein may be implemented as software instructions executed by a processor, suitably configured application specific integrated circuits (ASIC) or field programmable gate array (FPGA) modules, or any other convenient manner as would be appreciated by those skilled in the art. Where employed, the software instructions may also be embodied in a non-transitory device that is being vended and/or provided, and that is not a transitory, propagating signal and/or a signal per se. For instance, the non-transitory device may be or include a hard disk drive, solid state drive, or CD ROM. Flash drives may also be used for storing the instructions. Additionally, the software code instructions may also be downloaded over the Internet (e.g., as part of an application (“app”) or software file). Accordingly, it is to be understood that although a software application for undertaking present principles may be vended with a device such as the system 100 described below, such an application may also be downloaded from a server to a device over a network such as the Internet. An application can also run on a server and associated presentations may be displayed through a browser (and/or through a dedicated companion app) on a client device in communication with the server.

Software modules and/or applications described by way of flow charts and/or user interfaces herein can include various sub-routines, procedures, etc. Without limiting the disclosure, logic stated to be executed by a particular module can be redistributed to other software modules and/or combined together in a single module and/ or made available in a shareable library. Also, the user interfaces (UI)/graphical UIs described herein may be consolidated and/or expanded, and UI elements may be mixed and matched between UIs.

Logic when implemented in software, can be written in an appropriate language such as but not limited to hypertext markup language (HTML)-5, Java^{®}/JavaScript, C# or C++, and can be stored on or transmitted from a computer-readable storage medium such as a solid state drive (SSD), a random access memory (RAM), read-only memory (ROM), electrically erasable programmable read-only memory (EEPROM), a hard disk drive or solid state drive, compact disk read-only memory (CD-ROM) or other optical disk storage such as digital versatile disc (DVD), magnetic disk storage or other magnetic storage devices including removable thumb drives, etc.

In an example, a processor can access information over its input lines from data storage, such as the computer readable storage medium, and/or the processor can access information wirelessly from an Internet server by activating a wireless transceiver to send and receive data. Data typically is converted from analog signals to digital by circuitry between the antenna and the registers of the processor when being received and from digital to analog when being transmitted. The processor then processes the data through its shift registers to output calculated data on output lines, for presentation of the calculated data on the device.

Components included in one embodiment can be used in other embodiments in any appropriate combination. For example, any of the various components described herein and/or depicted in the Figures may be combined, interchanged or excluded from other embodiments.

The term “a” or “an” in reference to an entity refers to one or more of that entity. As such, the terms “a” or “an”, “one or more”, and “at least one” can be used interchangeably herein.

"A system having at least one of A, B, and C" (likewise "a system having at least one of A, B, or C" and "a system having at least one of A, B, C") includes systems that have A alone, B alone, C alone, A and B together, A and C together, B and C together, and/or A, B, and C together, etc.

The term “circuit” or “circuitry” may be used in the summary, description, and/or claims. The term “circuitry” includes all levels of available integration, e.g., from discrete logic circuits to the highest level of circuit integration such as VLSI, and includes programmable logic components programmed to perform the functions of an embodiment as well as processors (e.g., special-purpose processors) programmed with instructions to perform those functions.

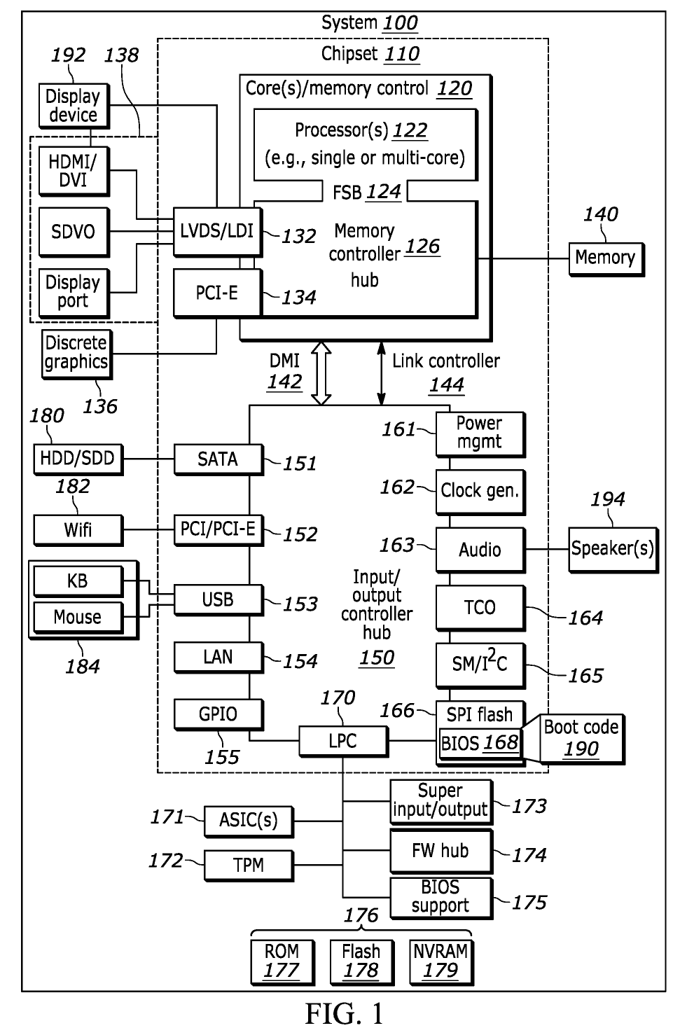

Now specifically in reference to FIG. 1, an example block diagram of an information handling system and/or computer system 100 is shown that is understood to have a housing for the components described below. Note that in some embodiments the system 100 may be a smartphone such as a Motorola® smartphone, a desktop computer system such as one of the ThinkCentre® computers, a notebook computer system such as one of the ThinkPad® series of personal computers or a workstation computer, such as the ThinkStation®, which are sold by Lenovo (US) Inc. of Morrisville, NC; however, as apparent from the description herein, a client device, a server or other machine in accordance with present principles may include other features or only some of the features of the system 100. Also, the system 100 may be, e.g., a game console such as XBOX®, and/or the system 100 may include a mobile communication device such as a mobile telephone, notebook computer, and/or other portable computerized device.

As shown in FIG. 1, the system 100 may include a so-called chipset 110. A chipset refers to a group of integrated circuits, or chips, that are designed to work together. Chipsets are usually marketed as a single product (e.g., consider chipsets marketed under the brands INTEL®, AMD®, etc.).

In the example of FIG. 1, the chipset 110 has a particular architecture, which may vary to some extent depending on brand or manufacturer. The architecture of the chipset 110 includes a core and memory control group 120 and an I/O controller hub 150 that exchange information (e.g., data, signals, commands, etc.) via, for example, a direct management interface or direct media interface (DMI) 142 or a link controller 144. In the example of FIG. 1, the DMI 142 is a chip-to-chip interface (sometimes referred to as being a link between a “northbridge” and a “southbridge”).

The core and memory control group 120 includes a processor system 122 (e.g., one or more single core or multi-core processors, etc.) and a memory controller hub 126 that exchange information via a front side bus (FSB) 124. A processor system such as the system 122 may therefore include one or more processors acting independently or in concert with each other to execute an algorithm, whether those processors are in one device or more than one device. Additionally, as described herein, various components of the core and memory control group 120 may be integrated onto a single processor die, for example, to make a chip that supplants the “northbridge” style architecture.

The memory controller hub 126 interfaces with memory 140. For example, the memory controller hub 126 may provide support for DDR SDRAM memory (e.g., DDR, DDR2, DDR3, etc.). In general, the memory 140 is a type of random-access memory (RAM). It is often referred to as “system memory.”

The memory controller hub 126 can further include a low-voltage differential signaling interface (LVDS) 132. The LVDS 132 may be a so-called LVDS Display Interface (LDI) for support of a display device 192 (e.g., a CRT, a flat panel, a projector, a touch-enabled light emitting diode (LED) display or other video display, etc.). A block 138 includes some examples of technologies that may be supported via the LVDS interface 132 (e.g., serial digital video, HDMI/DVI, display port). The memory controller hub 126 also includes one or more PCI-express interfaces (PCI-E) 134, for example, for support of discrete graphics 136. For example, the memory controller hub 126 may include a 16-lane (x16) PCI-E port for an external PCI-E-based graphics card (including, e.g., one or more GPUs). An example system may include AGP or PCI-E for support of graphics.

In examples in which it is used, the I/O hub controller 150 can include a variety of interfaces. The example of FIG. 1 includes a SATA interface 151, one or more PCI-E interfaces 152 (optionally one or more legacy PCI interfaces), one or more universal serial bus (USB) interfaces 153, a local area network (LAN) interface 154 (more generally a network interface for communication over at least one network such as the Internet, a WAN, a LAN, a Bluetooth network using Bluetooth 5.0 communication, etc. under direction of the processor(s) 122), a general purpose I/O interface (GPIO) 155, a low-pin count (LPC) interface 170, a power management interface 161, a clock generator interface 162, an audio interface 163 (e.g., for speakers 194 to output audio), a total cost of operation (TCO) interface 164, a system management bus interface (e.g., a multi-master serial computer bus interface) 165, and a serial peripheral flash memory/controller interface (SPI Flash) 166, which, in the example of FIG. 1, includes basic input/output system (BIOS) 168 and boot code 190. With respect to network connections, the I/O hub controller 150 may include integrated gigabit Ethernet controller lines multiplexed with a PCI-E interface port. Other network features may operate independent of a PCI-E interface. Example network connections include Wi-Fi as well as wide-area networks (WANs) such as 4G and 5G cellular networks.

The interfaces of the I/O hub controller 150 may provide for communication with various devices, networks, etc. For example, where used, the SATA interface 151 and/or PCI-E interface 152 provide for reading, writing or reading and writing information on one or more drives 180 such as HDDs, SSDs or a combination thereof, but in any case the drives 180 are understood to be, e.g., tangible computer readable storage mediums that are not transitory, propagating signals. The I/O hub controller 150 may also include an advanced host controller interface (AHCI) to support one or more drives 180. The PCI-E interface 152 allows for wireless connections 182 to devices, networks, etc. The USB interface 153 provides for input devices 184 such as keyboards (KB), mice and various other devices (e.g., cameras, phones, storage, media players, etc.).

In the example of FIG. 1, the LPC interface 170 provides for use of one or more ASICs 171, a trusted platform module (TPM) 172, a super I/O 173, a firmware hub 174, BIOS support 175 as well as various types of memory 176 such as ROM 177, Flash 178, and non-volatile RAM (NVRAM) 179. With respect to the TPM 172, this module may be in the form of a chip that can be used to authenticate software and hardware devices. For example, a TPM may be capable of performing platform authentication and may be used to verify that a system seeking access is the expected system.

The system 100, upon power on, may be configured to execute boot code 190 for the BIOS 168, as stored within the SPI Flash 166, and thereafter processes data under the control of one or more operating systems and application software (e.g., stored in system memory 140). An operating system may be stored in any of a variety of locations and accessed, for example, according to instructions of the BIOS 168.

Additionally, though not shown for simplicity, in some embodiments the system 100 may include a gyroscope that senses and/or measures the orientation of the system 100 and provides related input to the processor system 122, an accelerometer that senses acceleration and/or movement of the system 100 and provides related input to the processor system 122, and/or a magnetometer that senses and/or measures directional movement of the system 100 and provides related input to the processor system 122. Still further, the system 100 may include an audio receiver/microphone that provides input from the microphone to the processor system 122 based on audio that is detected, such as via a user providing audible input to the microphone. The system 100 may also include a camera that gathers one or more images and provides the images and related input (e.g., metadata like an image timestamp) to the processor system 122. The camera may be a thermal imaging camera, an infrared (IR) camera, a digital camera such as a webcam, a three-dimensional (3D) camera, and/or a camera otherwise integrated into the system 100 and controllable by the processor system 122 to gather still images and/or video.

Also, the system 100 may include a global positioning system (GPS) transceiver that is configured to communicate with satellites to receive/identify geographic position information and provide the geographic position information to the processor system 122. However, it is to be understood that another suitable position receiver other than a GPS receiver may be used in accordance with present principles to determine the location of the system 100.

It is to be understood that an example client device or other machine/computer may include fewer or more features than shown on the system 100 of FIG. 1. In any case, it is to be understood at least based on the foregoing that the system 100 is configured to undertake present principles.

Present principles may employ various machine learning models, including deep learning models. Machine learning models consistent with present principles may use various algorithms trained in ways that include supervised learning, unsupervised learning, semi-supervised learning, reinforcement learning, feature learning, self-learning, and other forms of learning. Examples of such algorithms, which can be implemented by computer circuitry, include one or more neural networks, such as a convolutional neural network (CNN), a recurrent neural network (RNN), and a type of RNN known as a long short-term memory (LSTM) network. Generative pre-trained transformers (GPTT) also may be used. Support vector machines (SVM) and Bayesian networks also may be considered to be examples of machine learning models. In addition to the types of networks set forth above, models herein may be implemented by classifiers.

As understood herein, performing machine learning may therefore involve accessing and then training a model on training data to enable the model to process further data to make inferences. An artificial neural network trained through machine learning may thus include an input layer, an output layer, and multiple hidden layers in between that are configured and weighted to make inferences about an appropriate output.

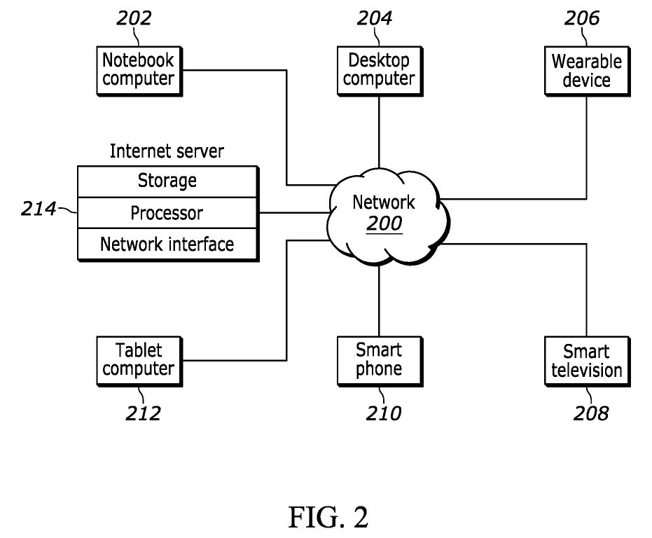

Turning now to FIG. 2, example devices are shown communicating over a network 200 such as the Internet in accordance with present principles. It is to be understood that each of the devices described in reference to FIG. 2 may include at least some of the features, components, and/or elements of the system 100 described above. Indeed, any of the devices disclosed herein may include at least some of the features, components, and/or elements of the system 100 described above.

FIG. 2 shows a notebook computer and/or convertible computer 202, a desktop computer 204, a wearable device 206 such as a smart watch, a smart television (TV) 208, a smart phone 210, a tablet computer 212, and a server 214 such as an Internet server that may provide cloud storage accessible to the devices 202-212. It is to be understood that the devices 202-214 may be configured to communicate with each other over the network 200 to undertake present principles.

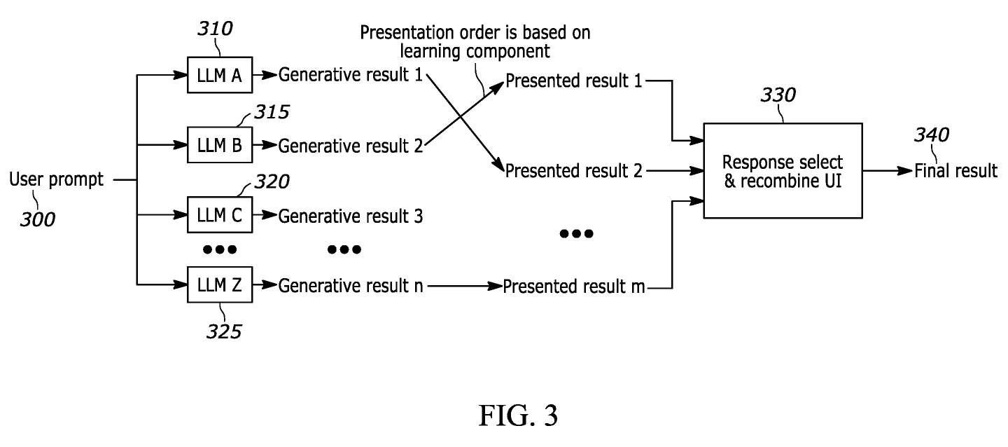

FIG. 3 shows a schematic diagram consistent with present principles. As shown, a user’s text prompt 300 may be provided as input to plural different LLMs, including LLM 310, LLM 315, LLM 320, and LLM 325. More or less LLMs may be used as long as the number is greater than one. Each LLM may provide a respective generative output in response to processing the prompt 300 through its respective layers.

Owing to the LLMs 310-325 being constructed and trained differently, each LLM 310-325 may output a different generative result 1-n as also shown in FIG. 3. A device operating consistent with present principles may then take the generative results 1-n and prioritize them as further shown in FIG. 3. Thus, the results 1-n may be rearranged in order into presented results 1-m as shown. Different examples of how the device might prioritize the different results will be discussed later. But note here that the presentation (prioritization) order for the results 1-m may be based on a learning component of software executing consistent with present principles, as will also be discussed in greater detail later.

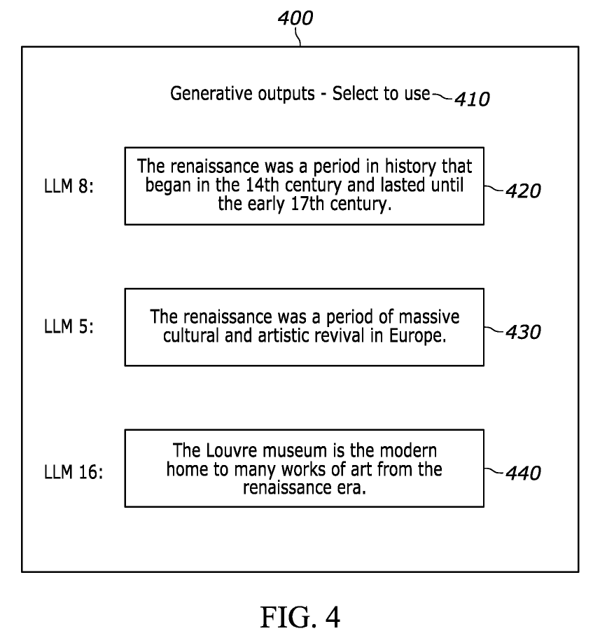

Still in reference to FIG. 3, note that the presented (prioritized) results 1-m may be presented as part of one or more response selection and recombination user interfaces (UIs) 330. An end-user may then manipulate the UI(s) 330 to arrive at a final text result 340 that the user wishes to adopt or otherwise use. Different examples of the UIs 330 are shown in reference to FIGS. 4-7.

Beginning first with FIG. 4, this figure shows an example graphical user interface (GUI) 400. However, note that in another example, the UIs 330 (including the GUI 400) may include audio components. E.g., certain outputs may be presented audibly, and user selections may be made through voice command. In any case, the GUI 400 of FIG. 4 shows that instructions 410 may be presented to the user to select one or more of the respective generative outputs to use for the user’s own text need.

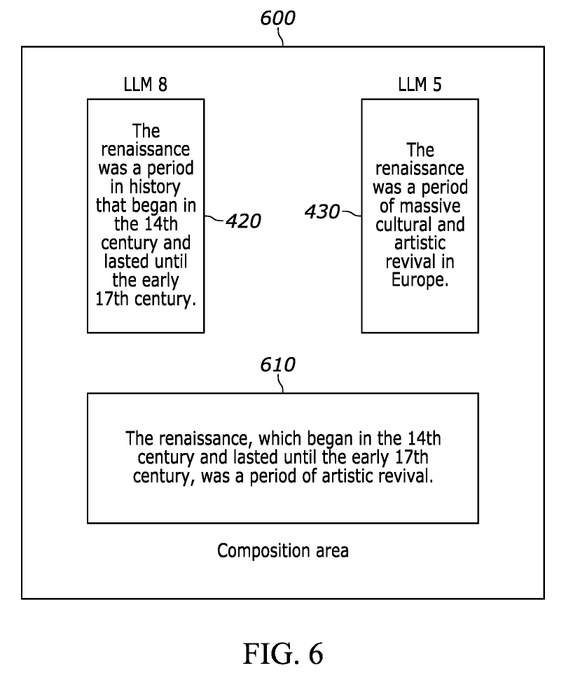

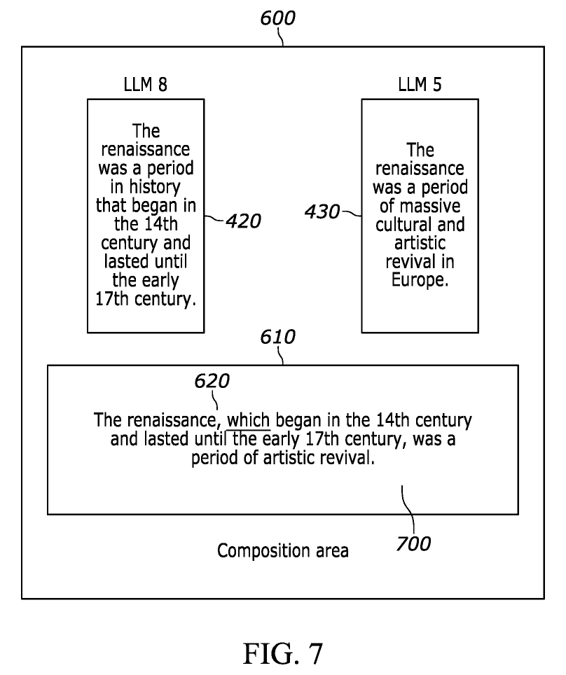

Beneath the instructions 410 may be respective generative text results/outputs 420, 430, and 440. One or more of the outputs 420-440 may be selected from the GUI 400 for the user to use the selected output(s) to form composite text from the respective outputs. Thus, selection of one or more of the outputs 420-440 may cause another GUI as shown in FIGS. 6 and 7 to be presented, as will be described in a moment.

Note in terms of FIG. 4 though that the outputs 420-440 have been prioritized through their concurrent presentation, here in a vertical sequence. The prioritization may be established based on previous user inputs selecting past outputs from respective LLMs that are now presented higher up in the presentation of FIG. 4 more than lower-down LLMs (whose outputs were selected less-frequently in the past). Thus, the highest-prioritized output (and hence respective LLM) is presented on at the top, with subsequent LLMs presented in descending order farther and farther downward according to descending order of prioritization.

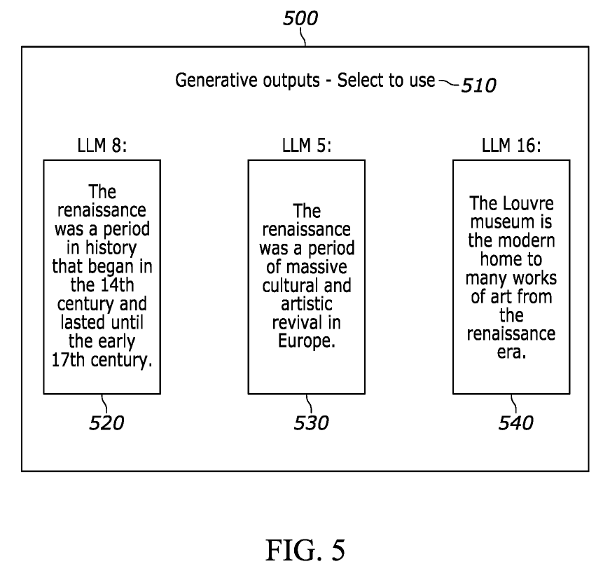

FIG. 5 then shows another example GUI 500 that is similar to the GUI 400, but with the selectable outputs 520, 530, and 540 being prioritized for presentation according to a left-to-right horizontal sequence. So here, the highest-prioritized output (and therefore LLM) is presented at the left-most position, with subsequent LLMs presented in descending order more and more to the right according to descending order of prioritization.

Turning to FIG. 6, this figure shows an example GUI 600 that may be presented responsive to the user selecting one or more of the outputs from the GUIs 400 or 500. Here, the user has selected the two highest-prioritized outputs from the GUI 400 for further drafting and editing, with those two outputs being concurrently presented as part of the GUI 600 as shown. The user may then cut and paste different parts of the text establishing either one of the generative text outputs 420, 430 from their location on the GUI 600 into a composition area 610. Different aspects of the generative texts 420, 430 that are selected by the user are therefore understood to be presentable in the area 610. Thus, the user can take different parts of the respective generative texts 420, 430 and place them into the composition area 610 to establish third text 620 that combines the two outputs texts, possibly with other user edits.

For example, a cursor may be directed to the area 610 to directly edit the text 620 in the area 610 using a hard or soft keyboard. The user might then cut or copy the final resulting text from the area 610 for pasting somewhere else, such as into a word processing document, into an email draft hosted by a web-based email service, etc.

Also note here that in some examples, yet another LLM different from the ones from which the prioritized outputs were received may be used to combine the text outputs 420, 430 into a clean text version as initially presented in the area 610 (for the user to then further edit if desired). This additional LLM may be one executing locally at the user’s client device and, as such, may be more lightly-built (e.g., less layers). This additional LLM may therefore be trained specifically for the task of text merging so that the LLM can run on the user’s client device without consuming undue amounts of processing power and energy. The local light-weight LLM may also help reduce latency time since the LLM would be running locally rather than in remotely-located cloud storage where communication latency might occur between the cloud and device. In any case, as indicated above, this additional LLM can take the text outputs from the other LLMs that were selected by the user via the GUIs 400 or 500, and then combine them into the single, clean (non-marked-up) text 620 presented in the composition area 610 as shown in FIG. 6.

However, FIG. 7 shows that in another example, this additional, text-combining LLM that is running locally on the user’s client device may present the combined text as a marked-up version 700 of a single body of text (rather than as clean a clean version of the combined text per FIG. 6). Accordingly, note that portions of the outputs 420, 430 that were not adopted by the local LLM (e.g., as part of clean text per FIG. 6) have been rendered on the GUI 700 with strike-through marking. Also note that additional text added by the text-combining local LLM have been rendered with underlining.

Further note that in addition to or in lieu of this third LLM being a local LLM as set forth above, in some examples this third LLM may be the same as either of the other two LLMs from which the respective outputs 420, 430 themselves were received.

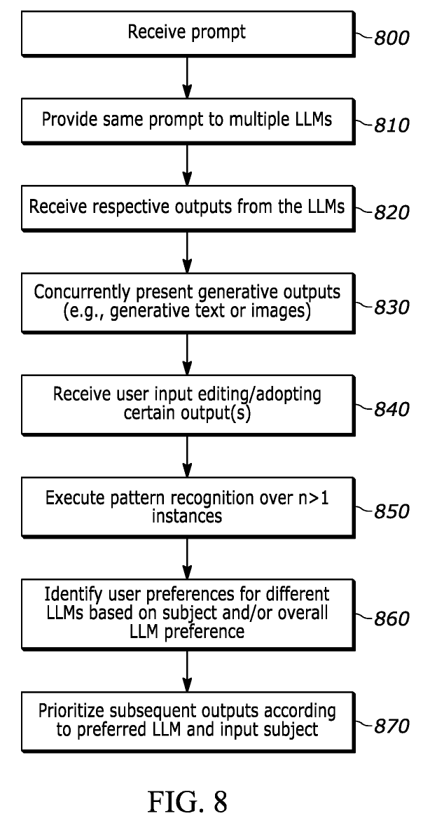

Turning now to FIG. 8, this figure shows example logic that may be executed by a device such as the system 100 and/or a coordinating server alone or in any appropriate combination consistent with present principles. Thus, in some examples the logic may be executed by a client device alone. In other examples, the logic may be executed by the remotely-located server alone. In still other examples, the logic may be executed by a client device and remotely-located server, where the client device performs some steps while the server performs other steps, and/or where the client device and server work together to perform a given step. Note that while the logic of FIG. 8 is shown in flow chart format, other suitable logic may also be used (e.g., state machine).

Beginning at block 800, the device may receive a prompt from a user, as might be entered into a prompt entry box presented as part of a GUI that itself is presented on the user’s device display. The logic may then proceed to block 810 where the device may provide the same prompt as received from the user as input to different LLMs to then, at block 820, receive a different output from each respective LLM in response. Each output may indicate respective different generative text from the respective LLM.

The logic may then proceed from block 820 to block 830 where the device may concurrently present, on a display, the generative texts that were output by the respective LLMs. For the purposes of the example of FIG. 8, assume the generative texts include first and second generative texts respectively from first and second LLMs.

The logic may then proceed to block 840 where the device receives user input editing and/or adopting certain aspects of one or both of the first and second outputs, such as according to the examples set forth above in reference to FIGS. 3-7. Thus, for example, at block 840 the device may receive user input selecting one or more outputs from the GUIs 400 or 500 to then present one of the GUIs 600 or 700 at which the user can subsequently copy and paste certain text into a composition area as described above. Other types of text select actions may be used as well, including voice commands, keyboard commands, and other mouse/cursor actions.

From block 840 the logic may then proceed to execute functions in relation to the aforementioned learning component. Specifically, at block 850 the device may execute pattern recognition over n>1 instances of presenting different generative texts on the display based on a respective prompt (e.g., more than one instance of executing steps 800 to 840 for different respective prompts for generative outputs). Pattern recognition may be performed using a recurrent neural network or other pattern recognition model, for example. Then based on execution of the pattern recognition model, at block 860 the device may, over the n>1 instances of presenting different generative texts on the display, identify a user’s preference for a particular LLM’s outputs based on the user selecting outputs from that LLM more than outputs from other LLMs. Then at block 860, based on the user’s identified preference, the device may prioritize future outputs from the user’s preferred LLM(s) for presentation over outputs from other LLMs when providing LLM output choices for a subsequent prompt in a subsequent instance.

Note here that the user’s preferred LLM may be an overall preferred LLM in that the pattern recognition model may recognize the user as preferring outputs from the preferred LLM in at least a plurality of all instances, if not a majority of all instances, by selecting the preferred LLM’s associated outputs more than those of other LLMs. Thus, in this example implementation, the preferred LLM may be one preferred by the user regardless of a subject to which the initial prompt itself pertains.

However, in other instances, the user’s preference may pertain to a particular type of subject such that the user may be identified as having a first LLM preference for a first type of subject and a second LLM preference for a second type of subject. So, for example, natural language processing techniques such as topic recognition and natural language understanding may be executed to identify a subject/topic of a given prompt received from the user. Pattern recognition may then be executed over n>1 instances of the user providing a prompt to track the user’s use of outputs from one LLM more than others for one subject, and outputs from another LLM more than the others for another subject.

As a particular non-limiting example, the user may be identified as preferring to use outputs from the LLM Gemini for political and social issues, to use outputs from the LLM Chat GPT for historical issues, and to use outputs from the LLM Llama for scientific issues. Those preferences may therefore be identified and tracked by the device of FIG. 8 to subsequently prioritize an output from one LLM preferred by the user for one topic, and to prioritize an output from another LLM preferred by the user for another topic.

Or as another example, note that crowdsourced data may additionally or alternatively be used. This may be done to determine which model multiple users prefer for a given subject to then prioritize outputs from that model when receiving subsequent prompts associated with the same subject.

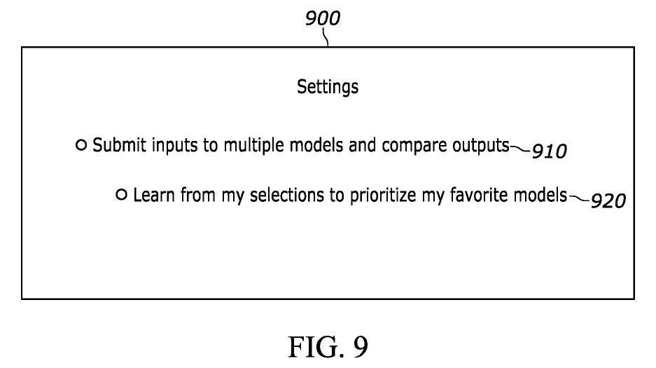

Also note before moving on to the description of FIG. 9 that while LLMs and text-based generative outputs have been discussed above, present principles may apply to generative models and generative outputs of other types as well. For instance, present principles may be applied to presenting outputs from different generative audio models and to presenting outputs from different generative image/video models. Thus, here too the device/app may identify the user’s preference for one generative audio or image model over another so that, after n>1 instances of selecting one generative image or generative audio from a given generative model over outputs from other models, subsequent outputs from the preferred model may be prioritized similar to as set forth above (e.g., presenting generative images or generative audio files higher up and/or more to the left on a GUI presented to the user, with lowest-prioritized outputs possibly being omitted from the GUI due to lack of space). In terms of generative image implementations in particular, further note that parts of different generative images may be segmented (or regions of the image) for adoption by the user. For both generative audio and generative images, a system may in some embodiments combine the results using another generative AI model (e.g., second pass, or otherwise).

What’s more, further note that infrequently-selected models, regardless of generative type, may be removed from the model set that is queried for any given prompt type (e.g., generative image prompt, generative text prompt, etc.). The removed models may even be replaced with alternate models that have not been used prior, with the removed models no longer being used for generative outputs once they fall below a weighting threshold and/or use threshold (e.g., some or all generative output from the respective model being used in less than five percent of all instances).

Now in reference to FIG. 9, this figure shows an example GUI 900 that may be presented on a client device display for an end-user to configure one or more settings of a device or software app to operate consistent with present principles. Each option discussed below may be selected by selecting the respective radio button shown adjacent to that option, whether through cursor input, touch input, or another type of input.

As shown, the GUI 900 may include a first option 910 that is selectable a single time to set or enable the device to, for multiple future instances of generative output production, concurrently present candidate generative outputs from different generative models for the user to then select one and place that output into a composition area. Therefore, the option 910 may be selected to set or configure the device to undertake the functions described above with respect to FIGS. 3-8.

The GUI 900 may also include another option 920 that may be selectable to, if not enabled via selection of the option 910, set or configure the device to execute pattern recognition to learn the user’s preferences for one model or another as set forth above to subsequently prioritize other outputs for different prompts in later instances.

It may now be appreciated that present principles provide for an improved computer-based user interface that increases the functionality and ease of use of the devices and models disclosed herein. The disclosed concepts are rooted in computer technology for computers to carry out their functions.

Components included in one embodiment can be used in other embodiments in any appropriate combination. For example, any of the various components described herein and/or depicted in the Figures may be combined, interchanged or excluded from other embodiments.

It is to be understood that whilst present principals have been described with reference to some example embodiments, these are not intended to be limiting, and that various alternative arrangements may be used to implement the subject matter claimed herein. Accordingly, while particular techniques and devices are herein shown and described in detail, it is to be understood that the subject matter which is encompassed by the present application is limited only by the claims.

WHAT IS CLAIMED IS:

1. A device, comprising:
a processor system; and
storage accessible to the processor system and comprising instructions executable by the processor system to:
receive a prompt;
provide the prompt as first input to a first large language model (LLM);
based on providing the prompt as first input to the first LLM, receive a first output from the first LLM, the first output indicating first generative text;
provide the prompt as second input to a second LLM;
based on providing the prompt as second input to the second LLM, receive a second output from the second LLM, the second output indicating second generative text; and
concurrently present, on a display, the first and second generative texts.

2. The device of claim 1, wherein the instructions are executable to:
present, concurrently on the display with the first and second generative texts, a composition area where different aspects of the first and second generative texts that are selected by a user are presentable such that the user can take different parts of the first and second generative texts and place them into the composition area to establish third text.

3. The device of claim 1, wherein the instructions are executable to:
over n>1 instances of presenting different generative texts on the display based on a respective prompt, identify a user’s preference for a particular LLM’s outputs based on the user selecting outputs from the particular LLM more than outputs from other LLMs; and
based on the user’s preference, prioritize future outputs from the particular LLM for presentation over outputs from other LLMs.

4. The device of claim 3, wherein the user’s preference pertains to a particular type of subject such that the user is identified as having a first LLM preference for a first type of subject and a second LLM preference for a second type of subject.

5. The device of claim 1, wherein the instructions are executable to:
concurrently present, in a vertical sequence on the display, the first and second generative texts.

6. The device of claim 1, wherein the instructions are executable to:
use a third LLM to synthesize the first and second generative texts into third text.

7. The device of claim 1, wherein the instructions are executable to:
concurrently present the first and second generative texts as combined text.

8. The device of claim 7, wherein the instructions are executable to:
render the combined text on the display as a marked-up version of a single body of text.

9. The device of claim 1, wherein the prompt is the same as provided to both the first and second LLMs as input.

10. The device of claim 1, wherein the second LLM is different from the first LLM.

11. The device of claim 1, comprising the display.

12. A method, comprising:
receiving a prompt;
providing the prompt as first input to a first large language model (LLM);
based on providing the prompt as first input to the first LLM, receiving a first output from the first LLM, the first output indicating first generative text;
providing the prompt as second input to a second LLM;
based on providing the prompt as second input to the second LLM, receiving a second output from the second LLM, the second output indicating second generative text; and
concurrently presenting, on a display, the first and second generative texts.

13. The method of claim 12, comprising:
presenting, concurrently on the display with the first and second generative texts, a composition area where different aspects of the first and second generative texts that are selected by a user are presentable such that the user can take different parts of the first and second generative texts and place them into the composition area to establish third text.

14. The method of claim 12, comprising:
over n>1 instances of presenting different generative texts on the display based on a respective prompt, identifying a user’s preference for a particular LLM’s outputs based on the user selecting outputs from the particular LLM more than outputs from other LLMs; and
based on the user’s preference, prioritizing future outputs from the particular LLM for presentation over outputs from other LLMs.

15. The method of claim 14, wherein the user’s preference pertains to a particular type of subject such that the user is identified as having a first LLM preference for a first type of subject and a second LLM preference for a second type of subject.

16. The method of claim 12, wherein the prompt is the same as provided to both the first and second LLMs as input.

17. The method of claim 12, wherein the second LLM is different from the first LLM.

18. At least one computer readable storage medium (CRSM) that is not a transitory signal, the at least one CRSM comprising instructions executable by a processor system to:
receive a prompt;
provide the prompt as first input to a model;
based on providing the prompt as first input to the first model, receive a first generative output from the first model;
provide the prompt as second input to a second model, the second model being different from the first model;
based on providing the prompt as second input to the second model, receive a second generative output from the second model; and
concurrently present, on a display, the first and second generative outputs.

19. The at least one CRSM of claim 18, wherein the instructions are executable to:
use a third model to synthesize the first and second generative outputs into a third output.

20. The at least one CRSM of claim 18, wherein the first and second generative outputs comprise one or more of: generative audio, generative images.
